(19) United States
(12) Patent Application Publication
(10) Pub. No.: US 2021/0047810 A1
(43) Pub. Date: Feb. 18, 2021

(54) PORTABLE DRINKING WATER GENERATOR

(71) Applicant: MICROJET TECHNOLOGY CO., LTD., Hsinchu City (TW)

(72) Inventors: Hao-Jan Mou, Hsinchu City (TW); Ching-Sung Lin, Hsinchu City (TW); Yung-Lung Han, Hsinchu City (TW); Chi-Feng Huang, Hsinchu City (TW); Chun-Yi Kuo, Hsinchu City (TW); Chang-Yen Tsai, Hsinchu City (TW); Wei-Ming Lee, Hsinchu City (TW)

(21) Appl. No.: 16/932,950

(22) Filed: Jul. 20, 2020

(30) Foreign Application Priority Data
Aug. 14, 2019 (TW) 108129017

(51) Int. Cl. E03B 3/28; B01D 5/00; B01D 53/26; C02F 3/00; C02F 1/68

(52) U.S. Cl. CPC E03B 3/28; B01D 5/0015; B01D 5/0072; C02F 2101/20; B01D 53/265; C02F 3/00; C02F 1/68; B01D 5/0075

(57) ABSTRACT

A portable drinking water generator includes a micro gas pump, a micro condenser module, and a micro liquid pump. The portable drinking water generator utilizes the micro gas pump to draw air and transmit the purified air to the micro condenser module. The water in the air is condensed into liquid water by the micro condenser module. Afterwards, the liquid water is collected and transported to a water purification module by the micro liquid pump. The liquid water is filtered by the water purification module and becomes drinkable drinking water. Therefore, the portable drinking water generator can achieve generating drinking water.

### CROSS-REFERENCE TO RELATED APPLICATION

This non-provisional application claims priority under 35 U.S.C. § 119(a) to Patent Application No. 108129017 filed in Taiwan, R.O.C. on Aug. 14, 2019, the entire contents of which are hereby incorporated by reference.

### BACKGROUND

### Technical Field

The present disclosure relates to a portable drinking water generator. In particular, to a portable drinking water generator which utilizes a micro gas pump to draw air, utilizes a micro condenser module to form liquid water, and then utilizes a micro liquid pump to transmit the liquid water.

### Related Art

Water is an irreplaceable basic resource in biological survival and development. Not only the places that are facing the shortage of water resources, even areas with abundant water resources encounter the problem that the water cannot be timely supplied when natural disasters such as typhoons and earthquakes occur. At such situation, if the water resource is transported by vehicles, a lot of manpower and material resources are consumed, and some places will still suffer a certain degree of shortage of drinking water. Even though there are already technologies for generating drinking water from air, most of the equipment is bulky and is difficult to be popularized. Therefore, how to provide instant and convenient drinking water generator is an important issue at current in all regions.

### SUMMARY

In general, one of the objects of present disclosure is to provide a portable drinking water generator including a micro gas pump, a micro condenser module, and a micro liquid pump. The portable drinking water generator utilizes the micro gas pump to draw air and transmit the purified air to the micro condenser module. The water in the air is condensed into liquid water by the micro condenser module. Afterwards, the liquid water is collected and transported to a water purification module by the micro liquid pump. The liquid water is filtrated by the water purification module, and thus the liquid water is turned into the drinkable drinking water. Therefore, the portable drinking water generator can generate drinking water.

To achieve the above mentioned purpose(s), a general embodiment of the present disclosure provides a portable drinking water generator including a body having an air inlet, an air outlet, a water outlet, and an accommodating space. An air filtration module is disposed at the air inlet to filtrate particles or suspension contained in air outside the body for generating a purified gas, so that the purified gas enters into the accommodating space. A micro gas pump is disposed at the air inlet to guide the purified gas to the accommodating space. A micro condenser module is disposed in the accommodating space to exchange heat with the purified gas in the accommodating space so as to condense the purified gas into a liquid water. A water collection chamber is disposed in the accommodating space and below the micro condenser module to collect the liquid water. A filtration chamber is disposed in the accommodating space and disposed between the water collection chamber and the water outlet, wherein the filtration chamber has a liquid channel being in communication with the water collection chamber. At least one micro liquid pump is disposed between the water collection chamber and the water outlet, wherein the micro liquid pump guides the liquid water collected by the water collection chamber to flow through the liquid channel and then to the water outlet, thereby discharging the liquid water out. A water purification module is disposed in the filtration chamber to filtrate the liquid water passing therethrough so as to generate a drinking water, wherein the drinking water is discharged out from the water outlet through the at least one micro liquid pump.

### BRIEF DESCRIPTION OF THE DRAWINGS

The disclosure will become more fully understood from the detailed description given herein below for illustration only, and thus not limitative of the disclosure, wherein:

FIG. 1 illustrates a schematic perspective view of a micro portable drinking water generator according to an exemplary embodiment of the present disclosure;

FIG. 2 illustrates a schematic structural view of a cooling chip in the micro portable drinking water generator according to the exemplary embodiment of the present disclosure;

FIG. 3A illustrates a front exploded view of a micro gas pump according to the first embodiment of the present disclosure;

FIG. 3B illustrates a rear exploded view of the micro gas pump shown in FIG. 3A;

FIG. 4A illustrates a schematic cross-sectional view of the micro gas pump according to the first embodiment of the present disclosure;

FIG. 4B illustrates a schematic cross-sectional view of a micro piezoelectric pump with another structure;

FIG. 5A to FIG. 5C illustrate schematic cross-sectional views showing the micro piezoelectric pump at different operation steps;

FIG. 6A illustrates a schematic exploded view of the micro gas pump according to the second embodiment of the present disclosure;

FIG. 6B illustrates a schematic cross-sectional view of the micro gas pump according to the second embodiment of the present disclosure;

FIG. 6C and FIG. 6D illustrate schematic cross-sectional views showing a micro blower pump at different operation steps;

FIG. 7A illustrates a schematic perspective view of the micro blower pump according to an exemplary embodiment of the present disclosure;

FIG. 7B illustrates a front exploded view of the micro blower pump shown in FIG. 7A;

FIG. 7C illustrates a rear exploded view of the micro blower pump shown in FIG. 7B;

FIG. 8A illustrates a front schematic perspective view of a valve body;

FIG. 8B illustrates a rear schematic perspective view of the valve body shown in FIG. 8A;

FIG. 9A illustrates a front schematic perspective view of a valve chamber base;

FIG. 9B illustrates a rear schematic perspective view of the valve chamber base shown in FIG. 9A;

FIG. 10 illustrates a schematic perspective view of a valve membrane;

FIG. 11 illustrates a schematic perspective view of an outer barrel;

FIG. 12A illustrates a front schematic perspective view of a valve cover;

FIG. 12B illustrates a rear schematic perspective view of the valve cover shown in FIG. 12A;

FIG. 13 illustrates a schematic cross-sectional view of a micro liquid pump according to an exemplary embodiment of the present disclosure;

FIG. 14A and FIG. 14B illustrate schematic cross-sectional views showing the micro liquid pump at different operation steps; and

FIG. 15 illustrates a schematic perspective view of a micro portable drinking water generator according to another exemplary embodiment of the present disclosure.

### DETAILED DESCRIPTION

The present disclosure will now be described more specifically with reference to the following embodiments. It is to be noted that the following descriptions of different embodiments of this disclosure are presented herein for purpose of illustration and description only, and it is not intended to limit the scope of the present disclosure.

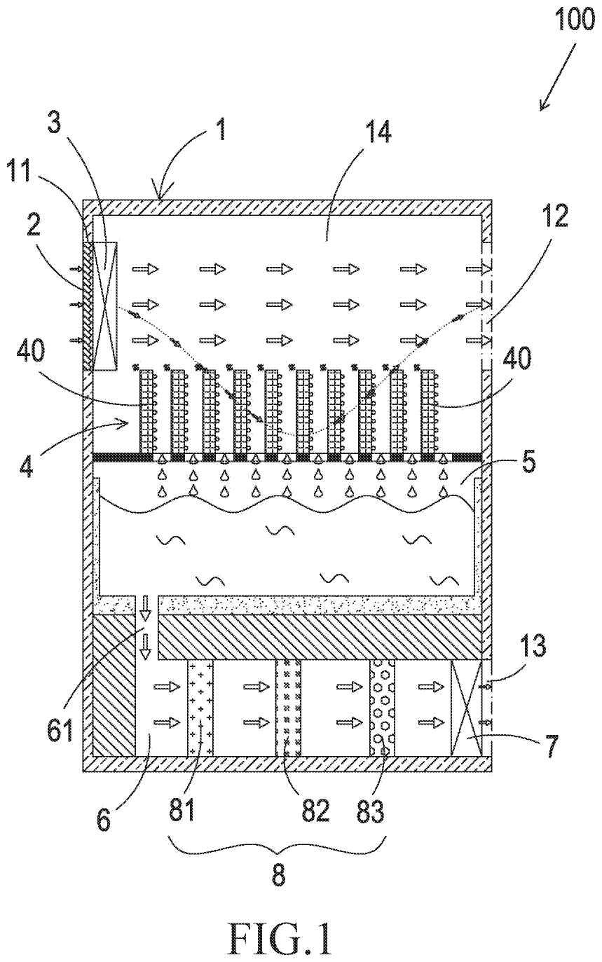

Please refer to FIG. 1. As shown in FIG. 1, in this embodiment, a portable drinking water generator 100 includes a body 1, an air filtration module 2, a micro gas pump 3, a micro condenser module 4, a water collection chamber 5, a filtration chamber 6, at least one micro liquid pump 7, and a water purification module 8. The body 1 has an air inlet 11, an air outlet 12, a water outlet 13, and an accommodating space 14. The air filtration module 2 is disposed at the air inlet 11, and the micro gas pump 3 is also disposed at the air inlet 11 and adjacent to the air filtration module 2. After the micro gas pump 3 is turned on, the micro gas pump 3 starts to draw the air outside the portable drinking water generator 100 into the accommodating space 14. When the air enters into the air inlet 11, the air is first filtrated by the air filtration module 2 disposed at the air inlet 11 so as to block the air pollutants which are harmful to the human body, such as pollen, dust, chemical smoke, suspended particles, bacteria, and microorganisms. Thus, the gas entering into the accommodating space 14 is a purified gas, thereby preventing the drinking water from having such pollutants.

The micro condenser module 4 is disposed in the accommodating space 14 and adjacent to the air inlet 11. When the purified gas generated by the air filtration module 2 enters into the accommodating space 14, the micro condenser module 4 performs heat exchange with the purified gas in the accommodating space 14 and decreases the temperature of the purified gas. Then, the temperature of the purified gas decreases to the dew point, and the purified gas starts to be condensed on the micro condenser module 4 as liquid water, thereby completing the process of generating water resource from air. The water collection chamber 5 is disposed in the accommodating space 14 and below the micro condenser module 4. After the liquid water condenses into dew on the surface of the micro condenser module 4 and continually accumulates, the liquid water gradually drops into the water collection chamber 5. The water collection chamber 5 converges and stores the liquid water dropping from the micro condenser module 4. The purified gas which is not condensed into liquid water is discharged out of the body 1 from the air outlet 12 through the gas flow generated by the micro gas pump 3. In this way, the gas discharged out from the air outlet 12 is the gas that has been purified, so that the portable drinking water generator 100 can provide clean air around the generator and achieve the effect of dehumidification. The micro condenser module 4 includes at least one condenser unit 40. In this embodiment, the micro condenser module 4 adopts multiple condenser units 40 arranged sequentially.

The filtration chamber 6 is disposed in the accommodating space 14 and disposed between the water collection chamber 5 and the water outlet 13. The filtration chamber 6 has a liquid channel 61 in communication with the water collection chamber 5, so that the liquid water in the water collection chamber 5 can enters into the filtration chamber 6 through the liquid channel 61. The micro liquid pump 7 is disposed between the water collection chamber 5 and the water outlet 13. In this embodiment, the micro liquid pump 7 is disposed at the water outlet 13 for providing the liquid water in the water collection chamber 5 with kinetic energy so as to guide the liquid water collected by the water collection chamber 5 to be discharged out from the water outlet 13 through the liquid channel 61. The water purification module 8 is disposed in the filtration chamber 6. When the liquid water is guided, by the micro liquid pump 7, from the water collection chamber 5 to the filtration chamber 6 through the liquid channel 61, the water purification module 8 in the filtration chamber 6 filtrates the liquid water passing therethrough so as to generate a drinking water which is drinkable and not harmful to human body. Last, the drinking water is discharged out from the water outlet 13 through the micro liquid pump 7, thereby completing the function of generating drinking water.

Please still refer to FIG. 1. The water purification module 8 includes a chemical filter 81 and a biological filter 82. By utilizing the chemical filter 81 and the biological filter 82, the heavy metal components possibly contained in the liquid water, chemical by-products from agriculture or industry around the life, and/or other related pollutants can be filtered, thereby preventing harmful substances from entering into a human body along with the liquid water. After the liquid water passes through the chemical filter 81 and the biological filter 82 to remove harmful substances contained in the liquid water, drinking water can be obtained. Moreover, the water purification module 8 may further include a mineralizer 83, which can mineralize the drinking water after the filtration, thereby adding trace elements and minerals necessary for human body to the drinking water. Accordingly, the trace elements and/or the minerals can be absorbed more easily by human body after drinking, which may be helpful for providing health maintenance.

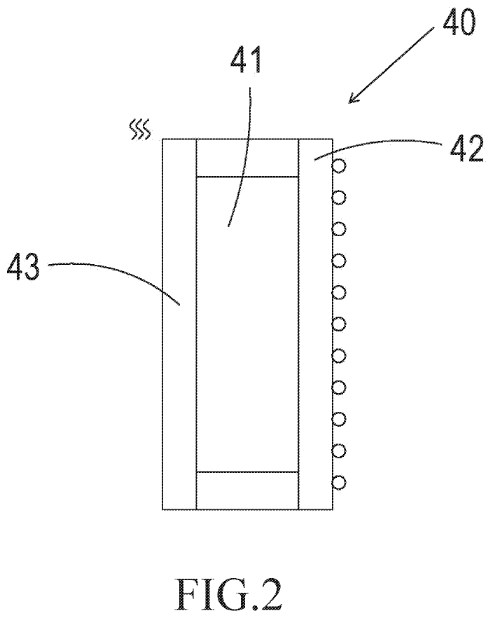

Please refer to FIG. 2. FIG. 2 illustrates a schematic structural view of a cooling chip according to the exemplary embodiment of the present disclosure. The condenser unit 40 includes a cooling chip 41, a condensation conducting element 42, and a heat conducting element 43, and the cooling chip 41 is between the condensation conducting element 42 and the heat conducting element 43. The cooling chip 41, the condensation conducting element 42 and the heat conducting element 43 are packaged together to form the condenser unit 40. The purified gas exchanges heat with the condensation conducting element 42 and condenses on the surface of the condensation conducting element 42. The heat that is produced during the cooling process (the condensation process) is transmitted to the heat conducting element 43, and is dissipated through the heat conducting element 43.

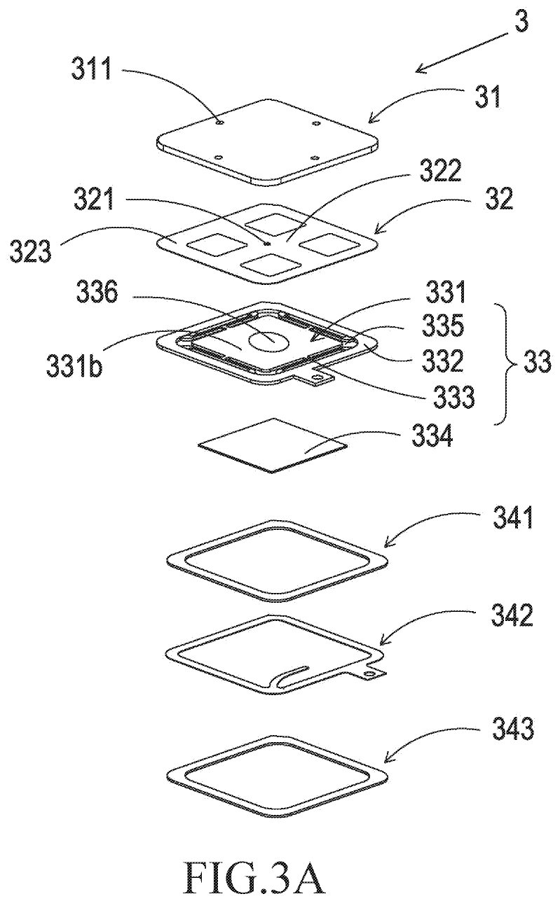

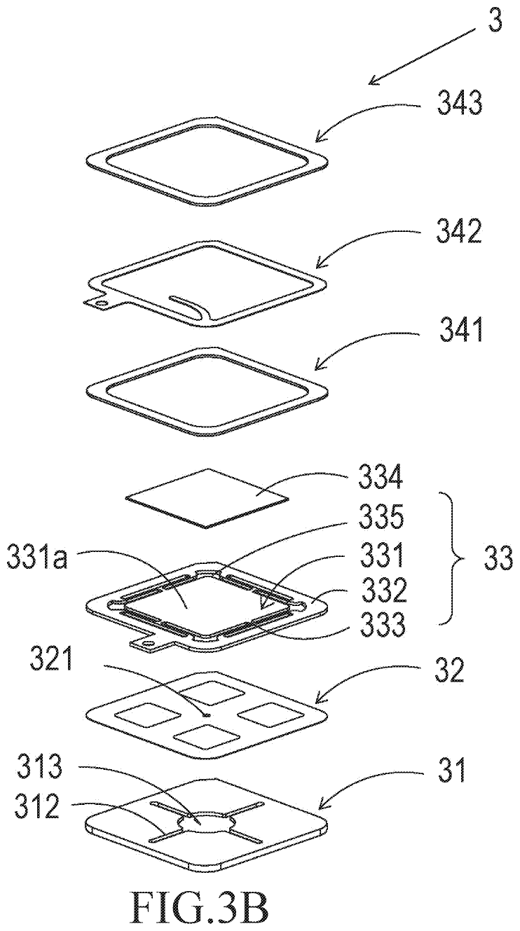

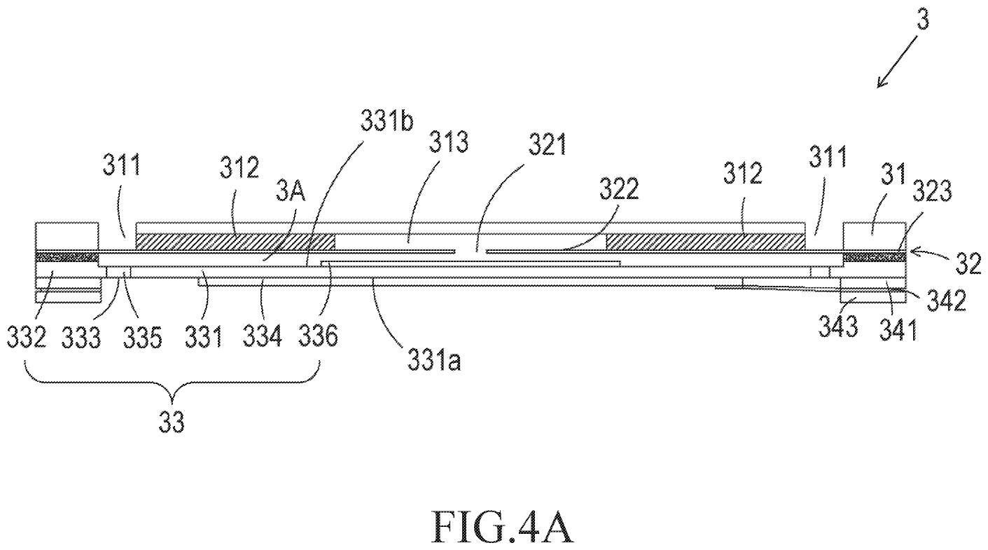

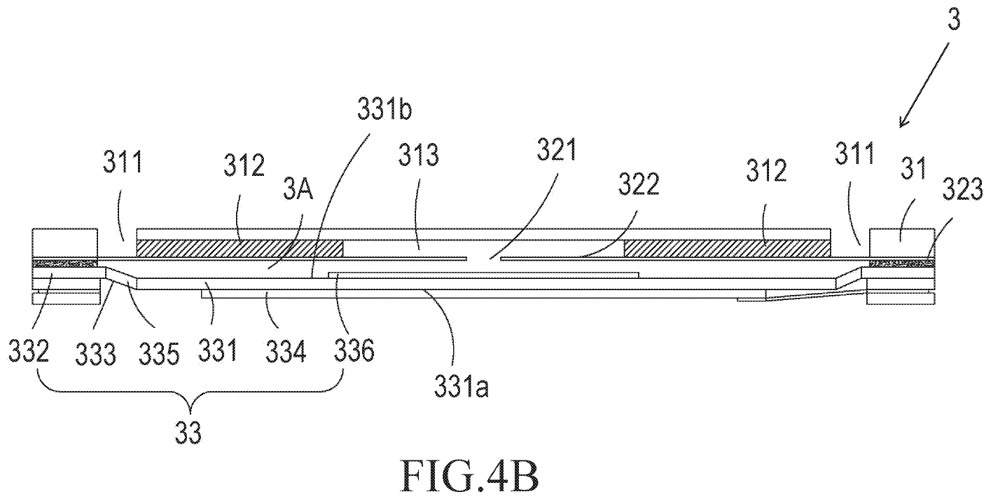

Please refer to FIG. 3A to FIG. 4A. FIG. 3A illustrates a front exploded view of the micro gas pump according to the first embodiment of the present disclosure. FIG. 3B illustrates a rear exploded view of the micro gas pump shown in FIG. 3A. FIG. 4A illustrates a schematic cross-sectional view of the micro gas pump according to the first embodiment of the present disclosure. The micro gas pump 3 may be a micro piezoelectric pump, which may include an inlet plate 31, a resonance plate 32, a piezoelectric actuator 33, a first insulation plate 341, a conductive plate 342, and a second insulation plate 343 sequentially stacked and assembled with each other.

The inlet plate 31 has at least one inlet hole 311, at least one convergence channel 312, and a convergence chamber 313. The inlet hole 311 guides the gas (purified gas) to flow into the micro piezoelectric pump. The inlet plate 31 has a top surface and a bottom surface opposite to the top surface, and the inlet hole 311 penetrates the inlet plate 31 from the top surface to the bottom surface. That is, the inlet hole 311 penetrates the inlet plate 31 and is in communication with the convergence channel 312, and the convergence channel 312 is in communication with the convergence chamber 313, so that the gas guided by the inlet hole 311 can be converged at the convergence chamber 313. In this embodiment, the number of the inlet hole 311 and the number of the convergence channel 312 are the same. As shown in FIG. 3A and FIG. 3B, the number of the inlet hole 311 and the number of the convergence channel 312 may be both four, but is not limited thereto. The four inlet holes 311 are respectively in communication with the four convergence channels 312, and the four convergence channels 312 are in communication with the convergence chamber 313.

The resonance plate 32 is attached to the inlet plate 31 through attaching, and the resonance plate 32 has a perforation 321, a movable portion 322, and a fixed portion 323. The perforation 321 is disposed at the center portion of the resonance plate 32 and corresponds to the convergence chamber 313 of the inlet plate 31. The movable portion 322 is disposed at the periphery of the perforation 321 and corresponds to the convergence chamber 313 of the inlet plate 31. The fixed portion 323 is disposed at the periphery of the resonance plate 32 and is used to be attached to the inlet plate 31.

The piezoelectric actuator 33 includes a suspension plate 331, an outer frame 332, at least one supporting element 333, a piezoelectric element 334, at least one gap 335, and a protruding portion 336. In the embodiments of the present disclosure, the suspension plate 331 is in square shape. It is understood that, the reason why the suspension plate 331 adopts the square shape is that, comparing with a circle suspension plate having a diameter equal to the side length of the square suspension plate 331, the square suspension plate 331 has an advantage of saving electricity. The power consumption of a capacitive load operated at a resonance frequency may increase as the resonance frequency increases, and since the resonance frequency of a square suspension plate 331 is much lower than that of a circular suspension plate, the power consumption of the square suspension plate 331 is relatively low as well. Consequently, the square design of the suspension plate 331 used in one or some embodiments of the present disclosure has the benefit of power saving. In the embodiments of the present disclosure, the outer frame 332 is disposed around the periphery of the suspension plate 331. At least one supporting element 333 is connected between the suspension plate 331 and the outer frame 332 to provide a flexible support for the suspension plate 331. In the embodiments of the present disclosure, the piezoelectric element 334 has a side length, which is shorter than or equal to a side length of the suspension plate 331. The piezoelectric element 334 is attached to a first surface 331a of the suspension plate 331 so as to drive the suspension plate 331 to bend and vibrate when the piezoelectric element 334 is applied with a voltage. At least one gap 335 is formed among the suspension plate 331, the outer frame 332, and the at least one connecting element 333, and the at least one gap 335 is provided for the gas to flow therethrough. The protruding portion 336 is disposed on a second surface 331b of the suspension plate 331 opposite to the first surface 331a of the suspension plate 331 where the piezoelectric element 334 is attached. In this embodiment, the protruding portion 336 may be a convex structure protruding out from the second surface 331b and integrally formed with the second surface 311b by performing an etching process on the suspension plate 331.

The first insulation plate 341, the conductive plate 342, and the second insulation plate 343 are all thin sheets with a frame like structure. The inlet plate 31, the resonance plate 32, the piezoelectric actuator 33, the first insulation plate 341, the conductive plate 342, and the second insulation plate 343 are sequentially stacked and assembled to form the main structure of the micro gas pump 3. A chamber space 3A needs to be formed between the suspension plate 331 and the resonance plate 32. The chamber space 3A can be formed by filling a material between the resonance plate 32 and the outer frame 332 of the piezoelectric actuator 33, such as conductive adhesive, but not limited thereto. By filling a material between the resonance plate 32 and the suspension plate 331, a certain distance can be maintained between the resonance plate 32 and the suspension plate 331 to form the chamber space 3A, by which the gas can be guided to flow more quickly. Further, since an appropriate distance is maintained between the suspension plate 331 and the resonance plate 32, the interference raised by the contact between the suspension plate 331 and the resonance plate 32 can be reduced, so that the generation of noise can be decreased as well. In other embodiments, the needed thickness of the conductive adhesive between the resonance plate 32 and the outer frame 332 of the piezoelectric actuator 33 can be decreased by increasing the height of the outer frame 332 of the piezoelectric actuator 33. Accordingly, during the forming process at the hot pressing temperature and the cooling temperature, the situation that the actual spacing of the chamber space 3A being affected by the thermal expansion and contraction of the conductive adhesive can be avoided, thereby decreasing the indirect effect of the hot pressing temperature and the cooling temperature of the conductive adhesive on the entire structure of the micro gas pump 3. Moreover, the height of the chamber space 3A also affects the transmission efficiency of the micro gas pump 3. Therefore, it is important that a fixed height of the chamber space 3A should be maintained for obtaining a micro gas pump 3 with stable transmission efficiency.

Please refer to FIG. 4B. FIG. 4B illustrates a schematic cross-sectional view of a micro piezoelectric pump with another structure. Most of the elements in this embodiment are similar to the elements in the previous embodiment, and descriptions for these repeated elements are omitted here. One of the differences between this embodiment and the foregoing embodiment(s) is that, in this embodiment, the suspension plate 331 can be extended out by a certain distance by stamping. The extension distance can be adjusted by at least one supporting element 333 between the suspension plate 331 and the outer frame 332 so as to make the second surface 331b of suspension plate 331 and the assembly surface of the outer frame 332 be non-coplanar. Furthermore, in this embodiment, the surface of the protruding portion 336 on the suspension plate 331 is not coplanar with the assembly surface of the outer frame 332. A few amount of filling material (such as the conductive adhesive) is applied on the assembly surface of the outer frame 332, and the piezoelectric actuator 33 is assembled to the resonance plate 32 by attaching the piezoelectric actuator 33 onto the fixed portion 323 of the resonance plate 32 through hot pressing. By stamping the suspension plate 331 of the piezoelectric actuator 33 to form the chamber space 3A, the chamber space 3A can be obtained by directly adjusting the extension distance of the suspension plate 331 of the piezoelectric actuator 33, which effectively simplifies the structural design of the chamber space 3A, and also simplifies the manufacturing process and shortens the manufacturing time of the chamber space 3A.

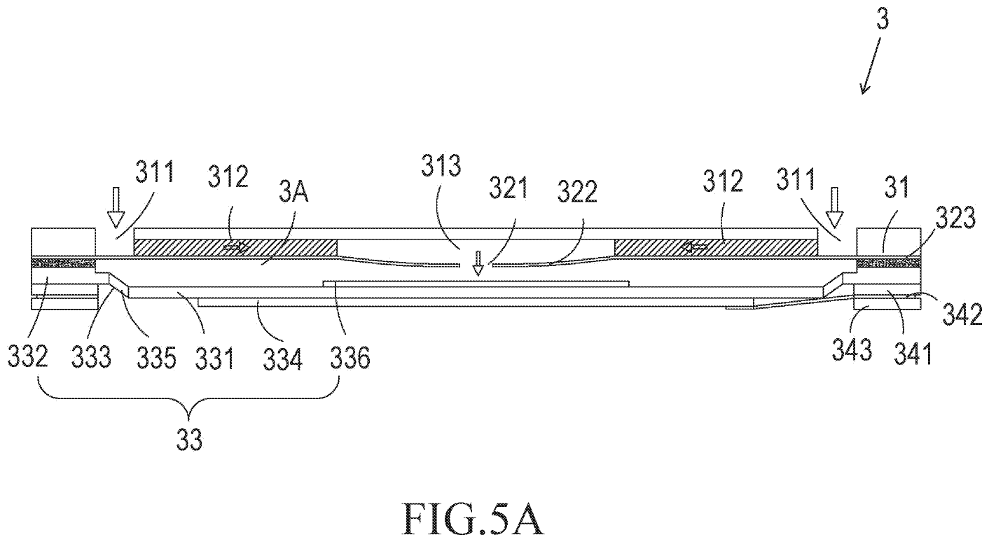

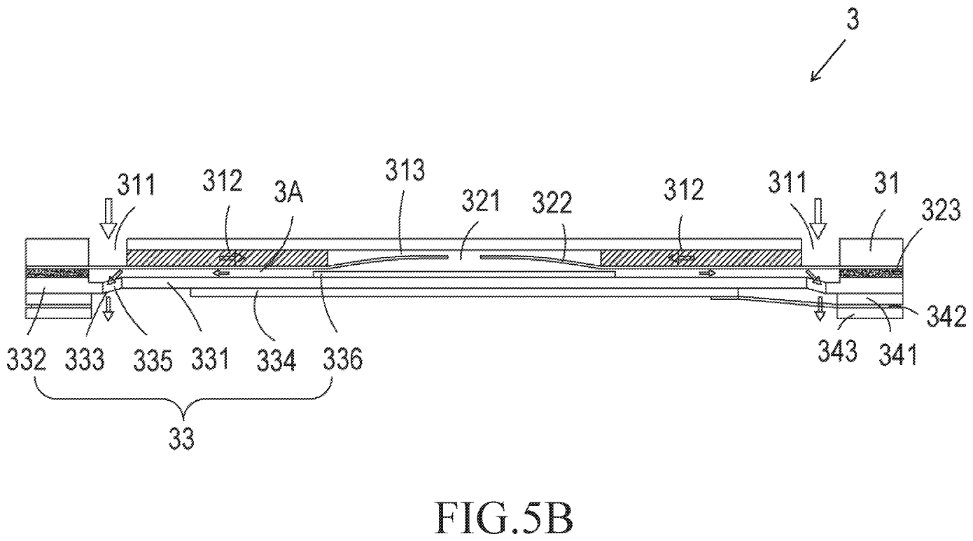

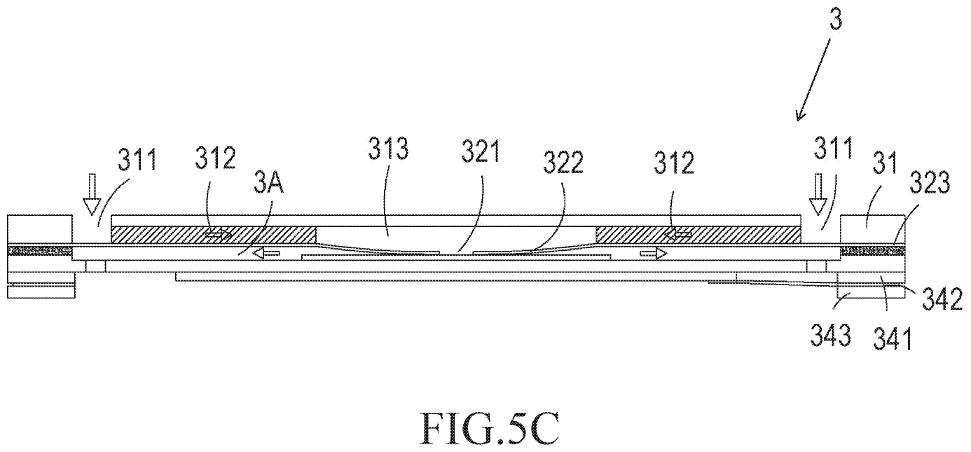

The operation of the micro gas pump 3 in this embodiment is similar to that of the micro piezoelectric pump of the first embodiment, and can be referred to FIG. 5A to FIG. 5C. Please refer to FIG. 5A first. The piezoelectric element 334 of the piezoelectric actuator 33 deforms after being applied with a driving voltage, and the piezoelectric element 334 drives the suspension plate 331 to move away from the inlet plate 31. Thus, the volume of the chamber space 3A is increased and a negative pressure is generated inside the chamber space 3A, thereby drawing the gas in the convergence chamber 313 into the chamber space 3A. At the same time, owing to the resonance effect, the resonance plate 32 is bent away from the inlet plate 31 correspondingly, which also increases the volume of the convergence chamber 313. Furthermore, since the gas inside the convergence chamber 313 is drawn into the chamber space 3A, the convergence chamber 313 is in a negative pressure state as well. Therefore, the gas can be drawn into convergence chamber 313 through the inlet hole 311 and the convergence channel 312. Then, please refer to FIG. 5B. The piezoelectric element 334 drives the suspension plate 331 to move toward the inlet plate 31, thereby compressing the chamber space 3A. Similarly, since the resonance plate 32 resonates with the suspension plate 331, the resonance plate 32 also moves toward the inlet plate 31, thereby pushing the gas in the chamber space 3A to be transmitted out of the chamber space 3A through the at least one gap 335 so as to achieve gas transmission. Last, please refer to FIG. 5C. When the suspension plate 331 moves resiliently to its original position, the resonance plate 32 still moves away from the inlet plate 31 due to its inertia momentum. At the time, the resonance plate 32 compresses the chamber space 3A, so that the gas in the chamber space 3A is moved toward the at least one gap 335 and the volume of the convergence chamber 313 is increased. Accordingly, the gas can be drawn into the micro gas pump 3 continuously through the inlet holes 311 and the convergence channels 312 and can be converged at the convergence chamber 313. By continuously repeating the operation steps of the micro gas pump 3 shown in FIG. 5A to FIG. 5C, the micro gas pump 3 can make the gas continuously enter into the flow paths formed by the inlet plate 31 and the resonance plate 32 from the inlet holes 311, thereby generating a pressure gradient. The gas is then transmitted outward through the at least one gap 335. As a result, the gas can flow at a relatively high speed, thereby achieving the effect of gas transmission.

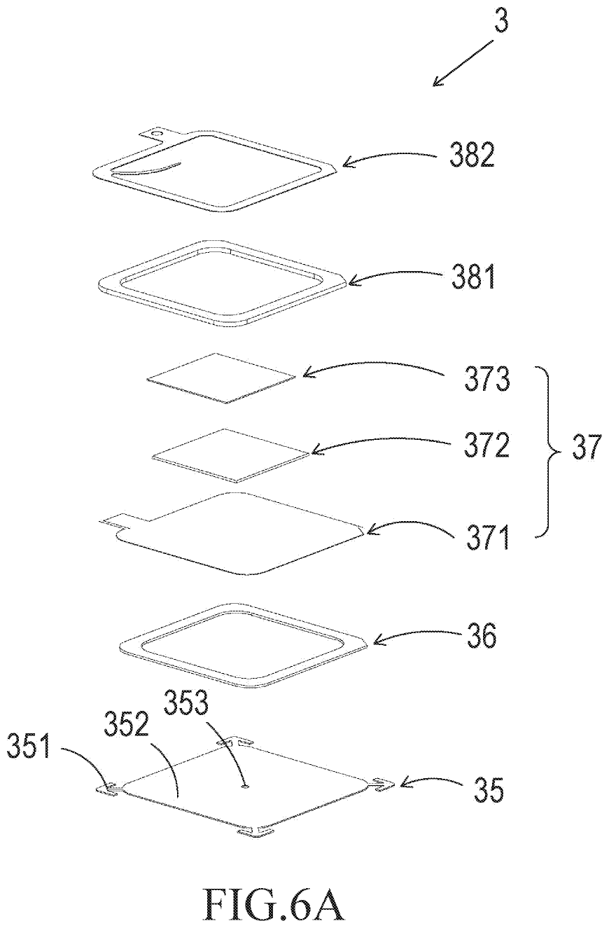

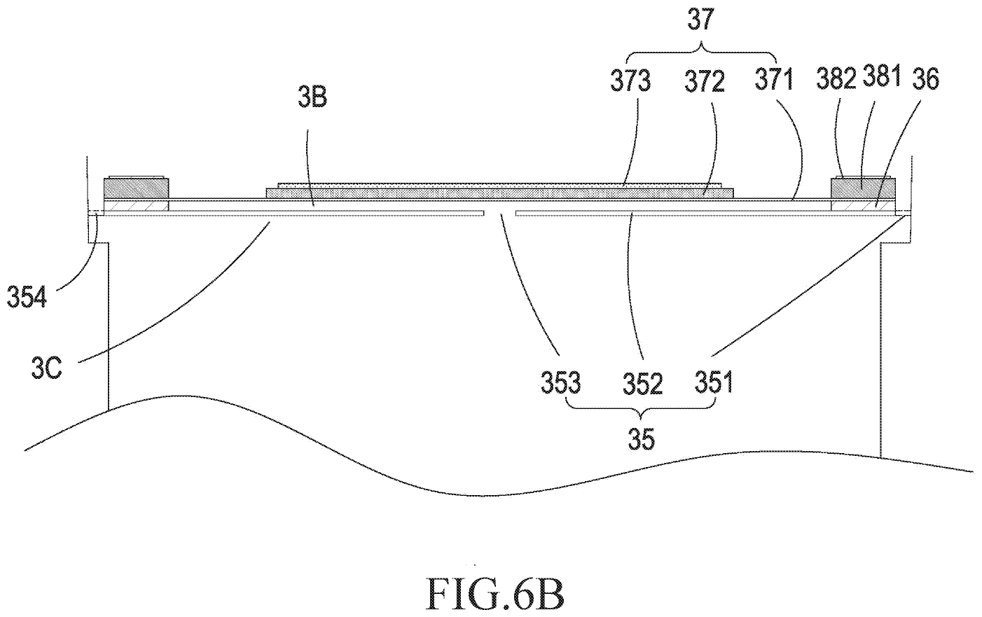

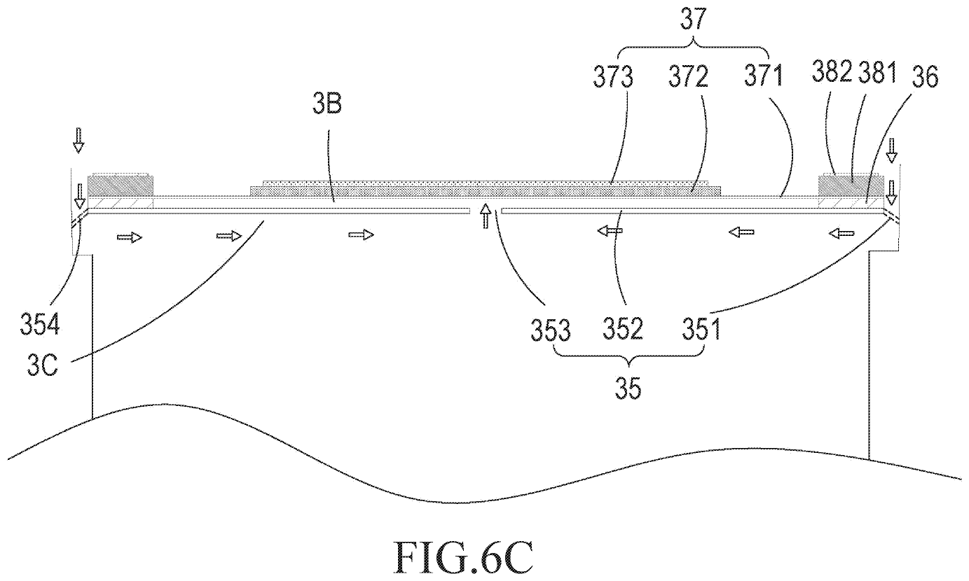

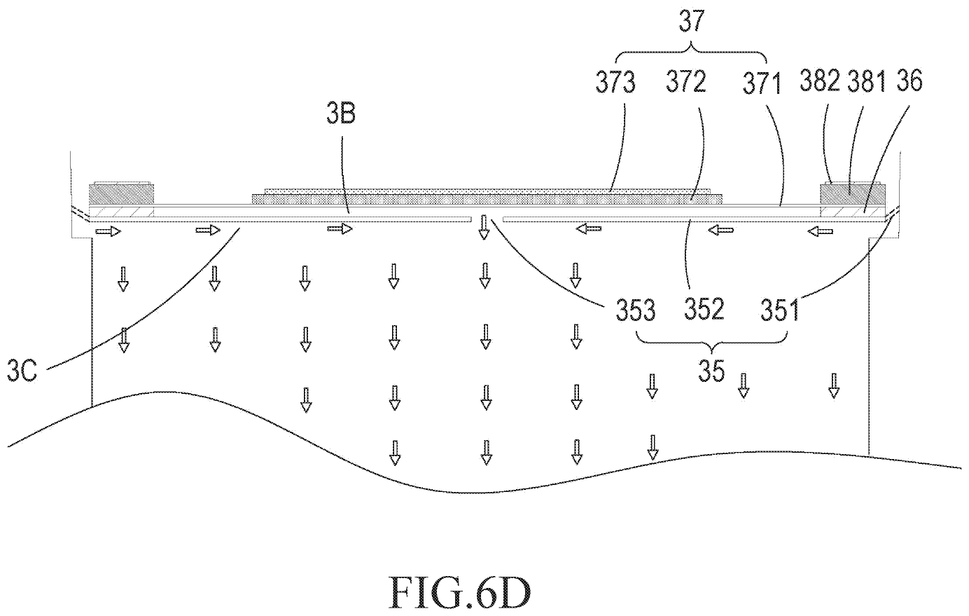

Please refer to FIG. 6A to FIG. 6D. In another embodiment, the micro gas pump 3 not only can be the micro piezoelectric pump mentioned above, but also can be a micro blower pump to implement gas transmission.

Please refer to FIG. 6A and FIG. 6B. FIG. 6A illustrates a schematic exploded view of the micro blower pump according to one or some embodiments of the present disclosure. FIG. 6B illustrates a schematic cross-sectional view of the micro blower pump according to one or some embodiments of the present disclosure. The micro blower pump includes a nozzle plate 35, a chamber frame 36, an actuator 37, an insulation frame 381, and a conductive frame 382, which are sequentially stacked and assembled with each other. The nozzle plate 35 includes a plurality of connecting elements 351, a suspension sheet 352, and a hollow hole 353. The suspension sheet 352 may bend and vibrate, and the connecting elements 351 are connected to the periphery of the suspension sheet 352. In this embodiment, the number of the connecting elements 351 is four, and the connecting elements 351 are respectively connected to the four corners of the suspension sheet 352, but is not limited thereto. The hollow hole 353 is formed at the center portion of the suspension sheet 352. The chamber frame 36 is attached to the suspension sheet 352. The actuator 37 is attached to the chamber frame 36, and the actuator 37 includes a piezoelectric substrate 371, an adjusting resonance plate 372, and a piezoelectric plate 373. The piezoelectric substrate 371 is attached to the chamber frame 36, the adjusting resonance plate 372 is attached to the piezoelectric substrate 371, and the piezoelectric plate 373 is attached to the adjusting resonance plate 372. After the piezoelectric plate 373 receives a voltage, the piezoelectric plate 373 is deformed to drive the piezoelectric substrate 371 and the adjusting resonance plate 372 to bend and vibrate reciprocatingly. The insulation frame 381 is attached to the piezoelectric substrate 371 of the actuator 37, and the conductive frame 382 is attached to the insulation frame 381. A resonance chamber 3B is formed among the actuator 37, the chamber frame 36, and the suspension sheet 352.

The operation steps of the micro blower pump can be referred to FIG. 6B to FIG. 6D. Please refer to FIG. 6B first. The micro blower pump is fixed by the connecting elements 351. An airflow chamber 3C is formed between the nozzle plate 35 and a bottom of the chamber accommodating the micro blower pump. Please refer to FIG. 6C. When the piezoelectric plate 373 of the actuator 37 is applied with a voltage, owing to the resonance effect, the piezoelectric plate 373 starts to deform and drive the adjusting resonance plate 372 and the piezoelectric substrate 371 to move at the same time. At the same time, the nozzle plate 35 is moved correspondingly owing to the Helmholtz resonance effect, by which the actuator 37 is moved away from the bottom of the chamber accommodating the micro blower pump. Due to the displacement of the actuator 37, the volume of the airflow chamber 3C is increased and thus the internal pressure of the airflow chamber 3C becomes negative. Therefore, because of the pressure gradient, the gas outside the micro blower pump can be drawn into the airflow chamber 3C through the gap 354 between two of the adjacent connecting elements 351, so that the pressure of the airflow chamber 3C starts to increase. Last, please refer to FIG. 6D. After the gas continuously enters into the airflow chamber 3C, the internal pressure of the airflow chamber 3C becomes positive. At the time, the actuator 37 is further driven by a voltage to move toward the bottom of the chamber accommodating the micro blower pump. The volume of the airflow chamber 3C is thus compressed and the gas in the airflow chamber 3C is pushed, so that the gas entering into the micro blower pump is pushed to be discharged out, thereby achieving the gas transmission.

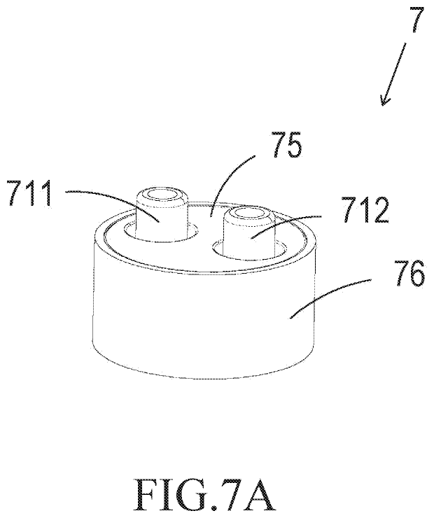

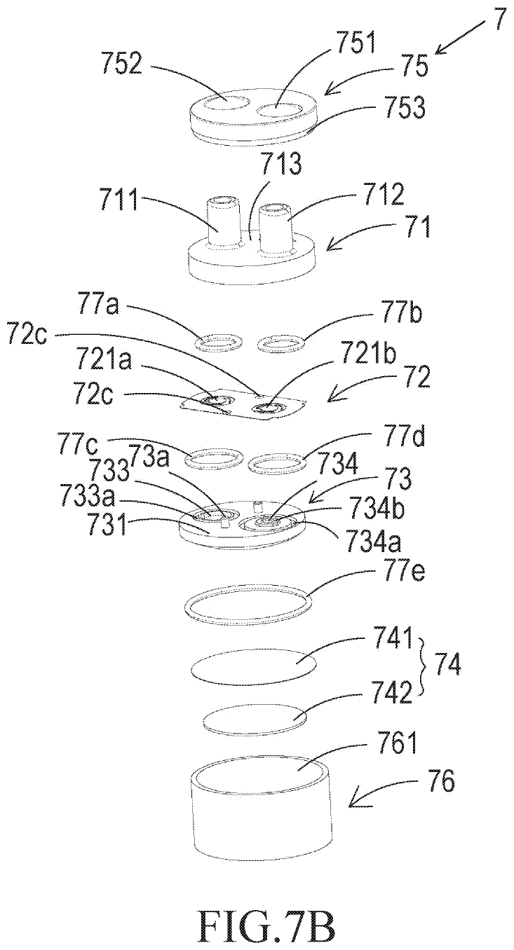

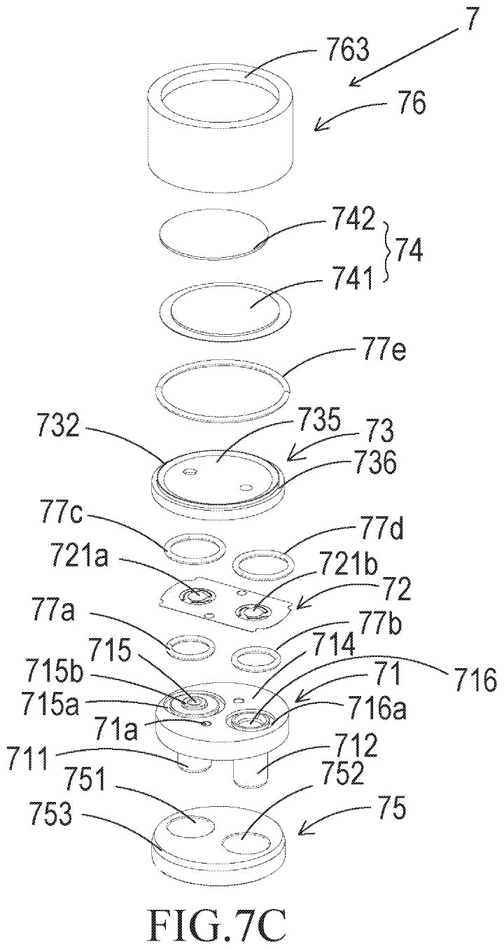

Please refer to FIG. 7A to FIG. 7C. FIG. 7A illustrates a schematic perspective view of the micro blower pump according to an exemplary embodiment of the present disclosure. FIG. 7B illustrates a front exploded view of the micro blower pump shown in FIG. 7A. FIG. 7C illustrates a rear exploded view of the micro blower pump shown in FIG. 7B. The micro liquid pump 7 includes a valve body 71, a valve plate 72, a valve chamber base 73, an actuating device 74, a valve cover 75, and an outer barrel 76.

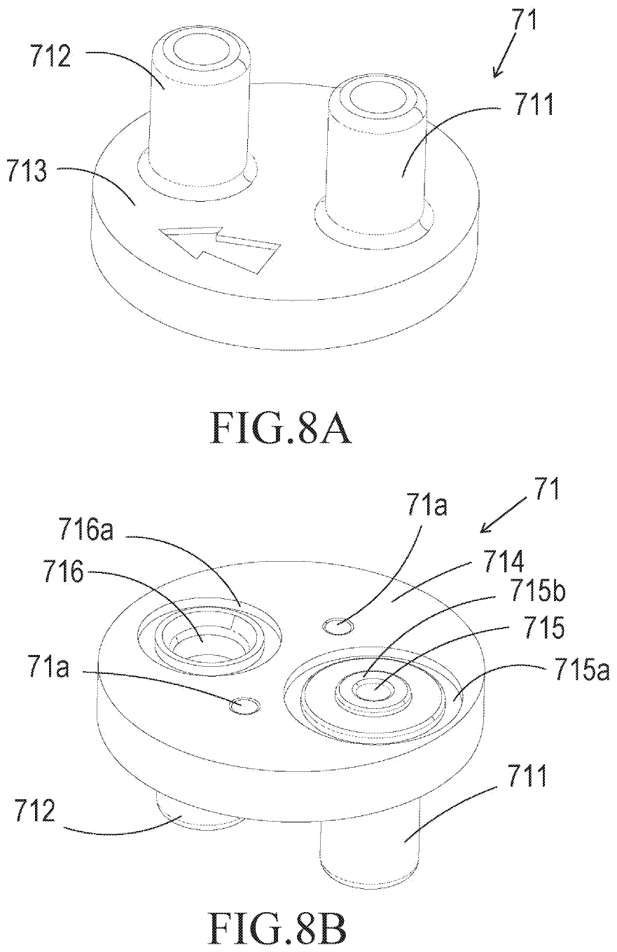

Please refer to FIG. 7A, FIG. 7B, FIG. 8A, and FIG. 8B. FIG. 8A illustrates a front schematic perspective view of a valve body 71. FIG. 8B illustrates a rear schematic perspective view of the valve body 71 shown in FIG. 8A. The valve body 71 has an inlet channel 711 and an outlet channel 712. The inlet channel 711 penetrates the valve body 71 from the first surface 713 to the second surface 714, and the outlet channel 712 also penetrates the valve body 71 from the first surface 713 to the second surface 714. The inlet channel 711 is in communication with an inlet opening 715 on the second surface 714. The second surface 714 has a groove 715a surrounding the inlet opening 715, and the second surface 714 has a convex structure 715b surrounding the inlet opening 715. The outlet channel 712 is in communication with an outlet opening 716 on the second surface 714. The second surface 714 has a groove 716a surrounding the outlet opening 716. A plurality of latch grooves 71a is disposed on the second surface 714 of the valve body 71.

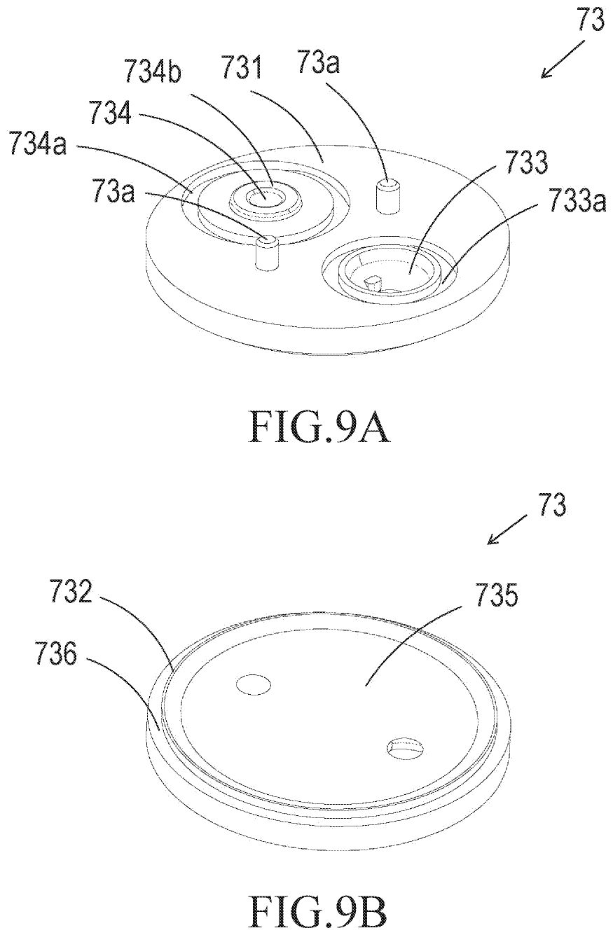

Please refer to FIG. 7A, FIG. 7B, FIG. 9A, and FIG. 9B. FIG. 9A illustrates a front schematic perspective view of a valve chamber base 73. FIG. 9B illustrates a rear schematic perspective view of the valve chamber base 73 shown in FIG. 9A. A plurality of latches 73a is disposed on the third surface 731 of the valve chamber base 73. Each of the latches 73a can be inserted in one corresponding latch groove 71a, by which the valve chamber base 73 is assembled with and positioned on the valve body 71. The valve chamber base 73 has an inlet valve channel 733 and an outlet valve channel 734. The inlet valve channel 733 penetrates the valve chamber base 73 from the third surface 731 to the fourth surface 732, and the outlet valve channel 734 also penetrates the valve chamber base 73 from the third surface 731 to the fourth surface 732. The third surface 731 has a groove 733a surrounding the inlet valve channel 733. The third surface 731 also has a convex structure 734b surrounding the outlet valve channel 734 and has a groove 734a surrounding the outlet valve channel 734. Moreover, the fourth surface 732 is recessed to form a pressure chamber 735 which is in communication with the inlet valve channel 733 and the outlet valve channel 734, and the fourth surface 732 has a step groove 736 outside the pressure chamber 735.

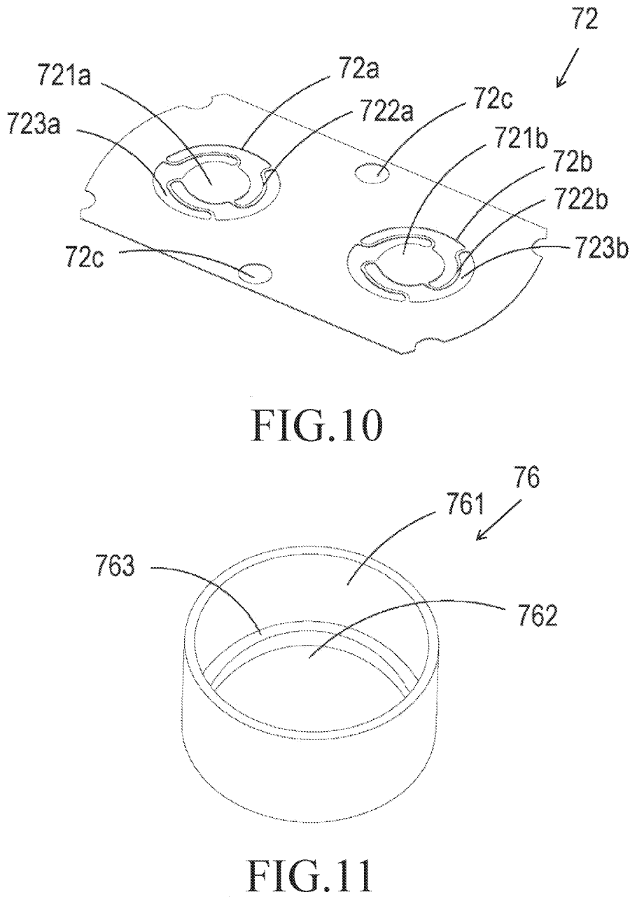

Please refer to FIG. 7A, FIG. 7B, and FIG. 10. In the case that the main material of the valve plate 72 is a polyimide (PI) polymer material, the manufacturing method of the valve plate 72 is the reactive ion etching (RIE) method. The reactive ion etching (RIE) method can be conducted by applying a photosensitive resist to the material where the valve structure is expected to be formed, and after the photosensitive resist is exposed and developed to form a valve structure pattern, the material is etched by the reactive ion. Since the portion of the polyimide plate covered by the photosensitive resist would not be etched, the desired valve structure can be etched on the valve plate 72. The valve plate 72 is a flat thin plate. As shown in FIG. 10. The valve plate 72 has two valve membranes 721a, 721b, both of which have the same thickness at two penetration areas 72a, 72b, respectively. A plurality of extending supporting elements 722a and a plurality of extending supporting elements 722b are disposed around the periphery of the two valve membranes 721a, 721b, respectively, for providing a flexible support for the two valve membranes 721a, 721b. A hollow hole 723a is formed between each of two adjacent the extending supporting elements 722a. Similarly, a hollow hole 723b is also formed between each of two adjacent the extending supporting elements 722b. Accordingly, the valve membranes 721a, 721b with the same thickness can be flexibly supported by the extending supporting elements 722a, 722b on the valve plate 72 and can be deformed with a certain displacement by a force, thereby extending and forming a valve switch structure. The valve membranes 721a, 721b can be circular, rectangular, square or various geometric forms, but not limited thereto. Moreover, the valve plate 72 has a plurality of positioning holes 72c corresponding to the plurality of the latches 73a on the third surface 731 of the valve chamber base 73, by which the plurality of the latches 73a can pass through the plurality of positioning holes 72c respectively so as to position the valve plate 72 on the valve chamber base 73. Thus, the valve membranes 721a, 721b can respectively cover the inlet valve channel 733 and the outlet valve channel 734 of the valve chamber base 73. In this embodiment, the number of the latches 73a is two, and thus the number of the positioning holes 72c is configured to be two as well, but not limited thereto. The number of the positioning holes 72c may depend on the number of the latches 73a.

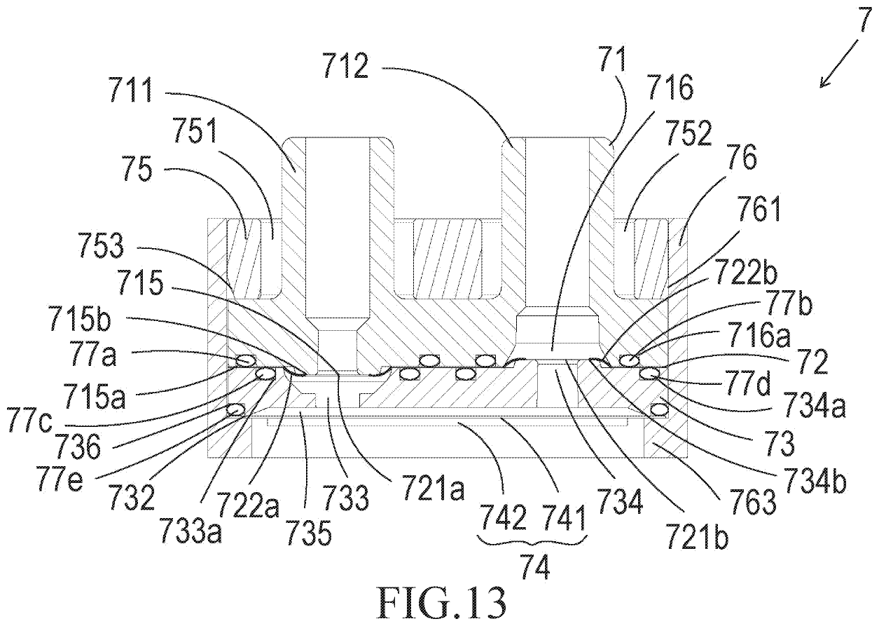

Please refer to FIG. 13. When the valve body 71 and the valve chamber base 73 are stacked and assembled together, the grooves 715a and the grooves 716a of the valve body 71 are provided for assembling with a sealing ring 77a and a sealing ring 77b, respectively. Similarly, the grooves 733a and the grooves 734a of the valve chamber base 73 are provided for assembling with a sealing ring 77c and a sealing ring 77d, respectively. Thus, after the valve body 71 and the valve chamber base 73 are assembled together, fluid leakage at the periphery of the grooves can be prevented by utilizing the sealing rings 77a, 77b, 77c, 77d. Hence, the inlet channel 711 of the valve body 71 corresponds to the inlet valve channel 733 of the valve chamber base 73, and the communication between the inlet channel 711 and the inlet valve channel 733 is controlled by the opening and closing of the valve membrane 721a of the valve plate 72. Similarly, the outlet channel 712 of the valve body 71 corresponds to the outlet valve channel 734 of the valve chamber base 73, and the communication between the outlet channel 712 and the outlet valve channel 734 is controlled by the opening and closing of the valve membrane 721b of the valve plate 72. When the valve membrane 721a of the valve plate 72 opens, the fluid guided by the inlet channel 711 can enter into and be converged at the pressure chamber 735 through the inlet valve channel 733. On the other hand, when the valve membrane 721b of the valve plate 72 opens, the fluid entering into the pressure chamber 735 can be discharged out through the outlet valve channel 734 and the outlet channel 712.

Please refer to FIG. 7A and FIG. 7B. The actuating device 74 includes a vibration plate 741 and a piezoelectric unit 742. The piezoelectric unit 742 is attached to the surface of the vibration plate 741. In this embodiment, the vibration plate 741 is made of metal. The piezoelectric unit 742 may be made of lead-zirconate-titanate (PZT) type piezoelectric powder with high piezoelectric constant. Accordingly, since the piezoelectric unit 742 is attached to the vibration plate 741, when the piezoelectric unit 742 is applied with a driving voltage, the piezoelectric unit 742 is deformed and thus make the vibration plate 741 bend and vibrate vertically and reciprocatingly, thereby driving the operation of the micro liquid pump 7. The vibration plate 741 is assembled on the fourth surface 732 of the valve chamber base 73 so as to cover the pressure chamber 735. The step groove 736 outside the pressure chamber 735 of the fourth surface 732 is provided for assembling with a sealing ring 77e, thereby preventing the periphery of the pressure chamber 735 from suffering fluid leakage.

From the above descriptions, it can be understood that, the valve body 71, the valve plate 72, the valve chamber base 73, and the actuating device 74 can be formed as the major structure for fluid guiding and transporting of the micro liquid pump 7. In some embodiments, in order to position and fix this stacked structure without using fastening elements (such as bolt, nut, screw, etc.), the design of the valve cover 75 and the outer barrel 76 of the present disclosure is adopted. First, the valve body 71, valve plate 72, valve chamber base 73, and actuating device 74 are staked sequentially with each other and placed in the outer barrel 76. Then, these stacked elements are held in the outer barrel 76 by the valve cover 75, which fits tightly with the interior of the outer barrel 76. In this way, these stacked elements are securely positioned inside the outer barrel 76, thereby forming the micro liquid pump 7 according to one or some embodiments of the present disclosure.

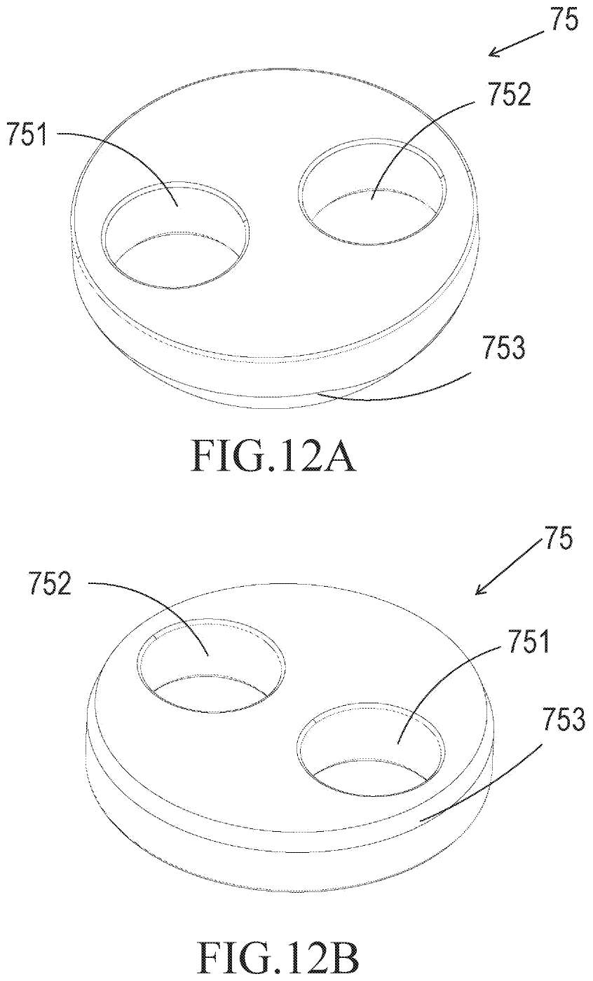

Please refer to FIG. 7A, FIG. 7B, and FIG. 11. The outer barrel 76 is made of metal, and the inner wall 761 of the outer barrel 76 encloses a hollow space 762. The bottom of the inner wall 761 of the outer barrel 76 has a convex ring structure 763. Please further refer to FIG. 12A and FIG. 12B. The valve cover 75 is also made of metal and has a first through hole 751 and a second through hole 752. The inlet channel 711 and the outlet channel 712 can be inserted into and pass through the first through hole 751 and the second through hole 752, respectively. The lower edge of the valve cover 75 has a chamfer 753, and the external diameter of the valve cover 75 is slightly greater than the internal diameter of the outer barrel 76.

Thus, as shown in FIG. 7A and FIG. 7B, the valve body 71, the valve plate 72, the valve chamber base 73, and the actuating device 74 are sequentially stacked and are in contact with the inner wall 761 of the outer barrel 76, and the stacked structure is carried on the convex ring structure 763 of the outer barrel 76. Since the external diameter of the valve cover 75 is slightly larger than the internal diameter of the outer barrel 76, by utilizing the chamfer 753, the valve cover 75 can be smoothly guided into the outer barrel 76 and tightly matched with the outer barrel 76, thereby securely positioning and assembling the valve body 71, the valve plate 72, the valve chamber base 73, and the actuating device 74 in order, and forming the micro liquid pump 7. The actuating device 74 is in the hollow space 762 of the outer barrel 76, and the vibration plate 741 of the actuating device 74 can be driven to bend and vibrate vertically and reciprocatingly when the piezoelectric unit 742 is applied with a voltage. Therefore, a micro liquid pump 7, which can be assembled and formed without using fastening elements (such as bolt, nut, screw, etc.), is obtained.

As shown in FIG. 13, in the micro liquid pump 7 according to one or some embodiments of the present disclosure, the inlet valve channel 733 of the valve chamber base 73 corresponds to the inlet opening 715 of the valve body 71. The valve membrane 721a of the valve plate 72 is used to serve as a valve between the inlet valve channel 733 and the inlet opening 715. The valve membrane 721a covers the inlet opening 715 of the valve body 71, and fits the convex structure 715b of the valve body 71 at the same time so as to generate a preforce. Such preforce helps the valve membrane 721a to be tightened up on the convex structure 715b and thus prevents the liquid from backflow. Similarly, the outlet valve channel 734 corresponds to the outlet opening 716 of the valve body 71. The valve membrane 721b of the valve plate 72 is used to serve as a valve between the outlet valve channel 734 and the outlet opening 716. The valve membrane 721b of the valve plate 72 covers the outlet valve channel 734 of the valve chamber base 73, and fits the convex structure 734b of the valve chamber base 73 at the same time so as to generate a preforce. Such preforce helps the valve membrane 721b to be tightened up on the convex structure 734b and thus prevents the liquid from backflow to the pressure chamber 735. Accordingly, when the micro liquid pump 7 of the present disclosure is not operated, no backflow problem occurs between the inlet channel 711 and the outlet channel 712.

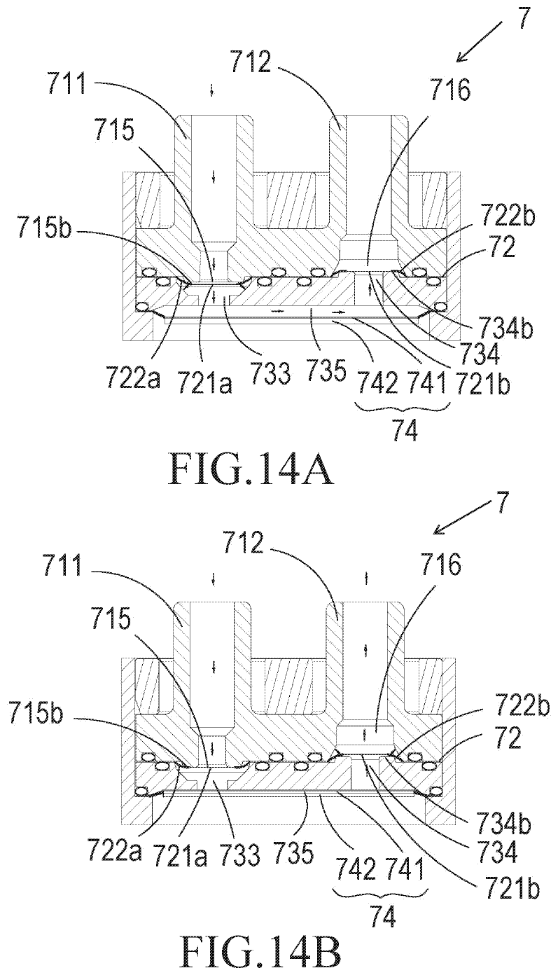

The operation steps of the micro liquid pump 7 for implementing the fluid transmission can be explained by FIG. 14A and FIG. 14B. As shown in FIG. 14A, when the piezoelectric unit 742 of the actuating device 74 is applied with a voltage and start to deform, the vibration plate 741 is driven to deform correspondingly. At that time, the volume of the pressure chamber 735 is increased and thus a suction force is generated. Hence, the valve membrane 721a of the valve plate 72 moves away from the convex structure 715b and opens the inlet channel 711 due to the suction force, by which a large amount of fluid can be drawn in the micro liquid pump 7 from the inlet channel 711 of the valve body 71. The fluid drawn in the micro liquid pump 7 passes through the inlet opening 715 of the valve body 71, the hollow hole 723a of the valve plate 72, and the inlet valve channel 733 of the valve chamber base 73, and then converges and is stored in the pressure chamber 735. Meanwhile, the outlet valve channel 734 is also under the suction force, so that the entire valve membrane 721b of the valve plate 72 is attracted downwardly, and the valve membrane 721b is closely and flatly attached to the convex structure 734b due to the suction force and the flexible support provided by the extending supporting elements 722b, thereby causing the outlet valve channel 734 now is in a closed state.

Afterwards, as shown in FIG. 14B, when the direction of the electric field applied to the piezoelectric unit 742 changes, the piezoelectric unit 742 drives the vibration plate 741 to bend upwardly. At that time, the volume of the pressure chamber 735 is decreased, so that the fluid inside the pressure chamber 735 is compressed and a push force is generated. Meanwhile, the inlet valve channel 733 is under the push force, so that the valve membrane 721a of the valve plate 72 is pushed upwardly, and the valve membrane 721a is flatly and closely attached to the convex structure 715b due to the push force and the flexible support provided by the extending supporting elements 722a, thereby causing the inlet channel 711 now is in a closed state. Hence, the fluid in the pressure chamber 735 cannot flow back to the inlet channel 711. On the other hand, the outlet valve channel 734 is under the push force as well. The entire valve membrane 721b of the valve plate 72 is pushed upwardly due to the push force and the flexible support provided by the extending supporting elements 722b, so that the valve membrane 721b moves upwardly and detaches from the convex structure 734b. Therefore, the outlet valve channel 734 is in an opened state, and the fluid can flow out of the pressure chamber 735 through the outlet valve channel 734. Then, the fluid can pass through the outlet valve channel 734 of the valve chamber base 73, the hollow hole 723b of the valve plate 72, the outlet opening 716 of the valve body 71, and the outlet channel 712, and can be discharged out from the micro liquid pump 7, thereby completing the fluid transmission. By repeating the operation shown in FIG. 14A and FIG. 14B, the liquid can be continuously transported. Moreover, the design of the micro liquid pump 7 according to one or some embodiments of the present disclosure can prevent the fluid from flowing back during the transmission process, thereby achieving a transmission with high efficiency.

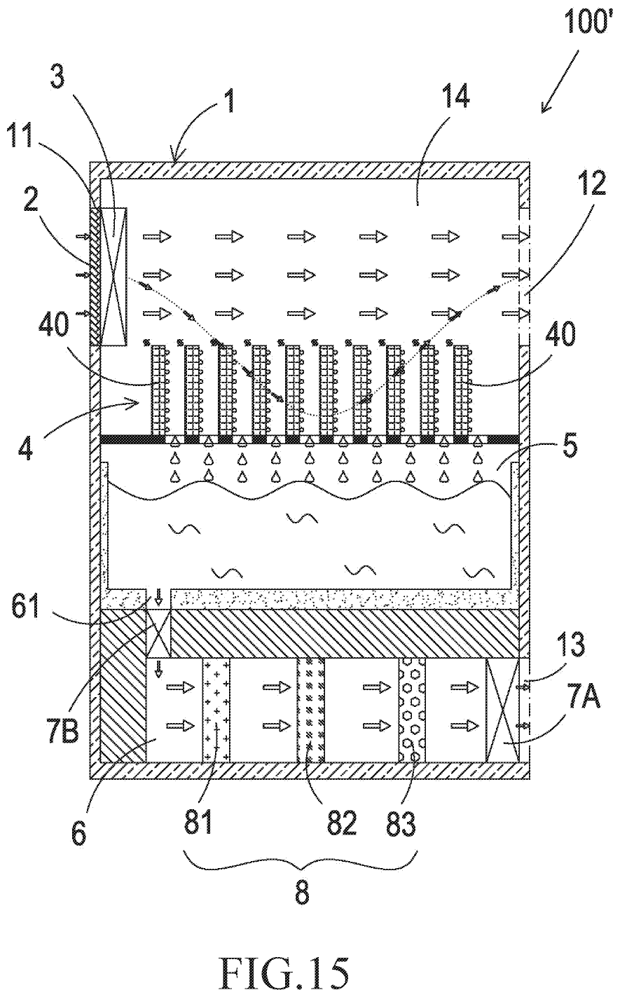

Please refer to FIG. 15. FIG. 15 illustrates a schematic perspective view of a micro portable drinking water generator according to another exemplary embodiment of the present disclosure. The difference between this embodiment and the previous embodiment is that, the number of the micro liquid pump 7 in this embodiment is two, which are respectively the first micro liquid pump 7A and the second micro liquid pump 7B. The first micro liquid pump 7A is disposed at the water outlet 13. The second micro liquid pump 7B is disposed in the liquid channel 61 and is adjacent to the water collection chamber 5, thereby providing the kinetic energy for the liquid water in the water collection chamber 5 to pass through the filtration chamber 6.

To sum up, one or some embodiments of the present disclosure provides a portable drinking water generator. The micro gas pump draws the gas. The cooling chips are used to form the micro condenser module, which is used to condense the gas into liquid water. Then, the micro liquid pump is used to provide the kinetic energy of transporting for the liquid water. By utilizing the micro gas pump, the condense module, and the liquid pump, the drinking water generator can be properly miniaturized. Since the drinking water generator is a portable item that can be carried with for a user, the user is free from concerning about the problem of drinking water shortage. Moreover, the air drawn into the portable drinking water generator will be filtrated first, and the air that has not been condensed into liquid water will be discharged out from the air outlet. At the time, the discharged air is purified air and dry air (because the air is filtrated and the water contained in the air has been condensed). Therefore, during the operation, the portable drinking water generator not only can provide drinking water, but also can provide purified gas to users surrounding the portable drinking water generator and can reduce the air humidity at the same time. The industrial value of the present application is very high, so the application is submitted in accordance with the law.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A portable drinking water generator, comprising:
a body having an air inlet, an air outlet, a water outlet, and an accommodating space;
an air filtration module disposed at the air inlet to filtrate particles or suspension contained in air outside the body for generating a purified gas, so that the purified gas enters into the accommodating space;
a micro gas pump disposed at the air inlet to guide the purified gas to the accommodating space;
a micro condenser module disposed in the accommodating space to exchange heat with the purified gas in the accommodating space so as to condense the purified gas into a liquid water;
a water collection chamber disposed in the accommodating space and below the micro condenser module to collect the liquid water;
a filtration chamber disposed in the accommodating space and disposed between the water collection chamber and the water outlet, wherein the filtration chamber has a liquid channel being in communication with the water collection chamber;
at least one micro liquid pump disposed between the water collection chamber and the water outlet, wherein the micro liquid pump guides the liquid water collected by the water collection chamber to flow through the liquid channel and then to the water outlet, thereby discharging the liquid water out; and
a water purification module disposed in the filtration chamber to filtrate the liquid water passing therethrough so as to generate a drinking water, wherein the drinking water is discharged out from the water outlet through the at least one micro liquid pump.

2. The portable drinking water generator according to claim 1, wherein the micro condenser module comprises at least one cooling chip, at least one condensation conducting element, and at least one heat conducting element, wherein the cooling chip, the condensation conducting element, and the heat conducting element are packaged together to form a condenser unit, wherein the condensation conducting element and the heat conducting element are respectively disposed on opposite sides of the cooling chip, so that the condensation conducting element functions as a heat exchange element during an operation of the cooling chip and the purified gas is condensed into the liquid water through the condensation conducting element.

3. The portable drinking water generator according to claim 1, wherein the at least one micro liquid pump comprises a first micro liquid pump disposed in the filtration chamber and adjacently connected to the water outlet so as to provide the liquid water with kinetic energy to be transmitted to the water outlet.

4. The portable drinking water generator according to claim 3, wherein the at least one micro liquid pump comprises a second micro liquid pump disposed in the liquid channel and adjacently connected to the water collection chamber so as to provide the liquid water in the water collection chamber with kinetic energy to be transmitted to the filtration chamber.

5. The portable drinking water generator according to claim 1, wherein the water purification module comprises a chemical filter and a biological filter.

6. The portable drinking water generator according to claim 5, wherein the water purification module further comprises a mineralizer.

7. The portable drinking water generator according to claim 1, wherein the micro gas pump is a micro piezoelectric pump and comprises:
an inlet plate having at least one inlet hole, at least one convergence channel, and a convergence chamber, wherein the inlet hole is configured to introduce the purified gas into the micro piezoelectric pump, and wherein the inlet hole correspondingly penetrates the inlet plate and is in communication with the convergence channel, and the convergence channel is in communication with the convergence chamber, so that the purified gas introduced by the inlet hole is converged at the convergence chamber;
a resonance plate attached to the inlet plate, and the resonance plate has a perforation, a movable portion, and a fixed portion, wherein the perforation is disposed at a center portion of the resonance plate and corresponds to the convergence chamber of the inlet plate, the movable portion is disposed around a periphery of the perforation and corresponds to the convergence chamber, the fixed portion is disposed around a periphery of the resonance plate and is attached on the inlet plate; and
a piezoelectric actuator attached to the resonance plate, wherein the piezoelectric actuator is correspondingly disposed to the resonance plate;
wherein a chamber space is formed between the resonance plate and the piezoelectric actuator, so that when the piezoelectric actuator is driven, the purified gas is guided into the micro piezoelectric pump through the inlet hole of the inlet plate, is converged at the convergence chamber via the convergence channel, flows through the perforation of the resonance plate, and then is transmitted owing to a resonance effect between the piezoelectric actuator and the movable portion of the resonance plate.

8. The portable drinking water generator according to claim 1, wherein the piezoelectric actuator comprises:
a suspension plate in square shape and capable of bending and vibrating;
an outer frame disposed around a periphery of the suspension plate;
at least one supporting element connected between the suspension plate and the outer frame to provide a flexible support for the suspension plate; and
a piezoelectric element having a side length, wherein the side length of the piezoelectric element is smaller than or equal to a side length of the suspension plate, and the piezoelectric element is attached to a first surface of the suspension plate so as to drive the suspension plate to bend and vibrate when the piezoelectric element is applied with a voltage.

9. The portable drinking water generator according to claim 8, wherein the suspension plate has a protruding portion disposed on a second surface of the suspension plate opposite to the first surface of the suspension plate, and the piezoelectric element is attached to the first surface of the suspension plate.

10. The portable drinking water generator according to claim 9, wherein the micro gas pump further comprises a first insulation plate, a conductive plate, and a second insulation plate, wherein the inlet plate, the resonance plate, the piezoelectric actuator, the first insulation plate, the conductive plate, and the second insulation plate are sequentially stacked and assembled with each other.

11. The portable drinking water generator according to claim 7, wherein the piezoelectric actuator comprises:
a suspension plate in square shape and capable of bending and vibrating;
an outer frame disposed around a periphery of the suspension plate;
at least one supporting element connected between the suspension plate and the outer frame to provide a flexible support for the suspension plate, wherein a second surface of the suspension plate and an assemble surface of the outer frame are non-coplanar, so that a chamber space is maintained between the second surface of the suspension plate and the resonance plate; and
a piezoelectric element having a side length, wherein the side length of the piezoelectric element is smaller than or equal to a side length of the suspension plate, and the piezoelectric element is attached to a first surface of the suspension plate so as to drive the suspension plate to bend and vibrate when the piezoelectric element is applied with a voltage.

12. The portable drinking water generator according to claim 1, wherein the micro gas pump is a micro blower pump, comprising:
a nozzle plate comprising a plurality of connecting elements, a suspension sheet, and a hollow hole, wherein the suspension sheet is capable of bending and vibrating, the plurality of connecting elements is connected to a periphery of the suspension sheet, and the hollow hole is formed at a center portion of the suspension sheet, wherein the suspension sheet is fixed by the plurality of connecting elements, the plurality of connecting elements provides the suspension sheet with a flexible support, and at least one gap is formed among the plurality of connecting elements and the suspension sheet;
a chamber frame attached on the suspension sheet;
an actuator attached on the chamber frame so as to be bent to vibrate reciprocatingly when the actuator is applied with a voltage;
an insulation frame attached on the actuator; and
a conductive frame attached on the insulation frame;
wherein a resonance chamber is formed among the actuator, the chamber frame, and the suspension sheet, wherein the actuator is driven to move the nozzle plate owing to a resonance effect, and the suspension sheet of the nozzle plate is bent to vibrate reciprocatingly, thereby making the purified gas flow through the at least one gap, enter into the resonance chamber, and then be discharged out from the resonance chamber, and transmission of the gas is achieved.

13. The portable drinking water generator according to claim 12, wherein the actuator comprises:
a piezoelectric substrate attached on the chamber frame;
an adjusting resonance plate attached on the piezoelectric substrate; and
a piezoelectric plate attached on the adjusting resonance plate so as to receive a voltage and drive the piezoelectric substrate and the adjusting resonance plate to be bent to vibrate reciprocatingly.

14. The portable drinking water generator according to claim 1, wherein the micro liquid pump comprises:
a valve body having an inlet channel, an outlet channel, a first surface, and a second surface, wherein the inlet channel and the outlet channel penetrate the valve body from the first surface to the second surface, the inlet channel is in communication with an inlet opening on the second surface, and the outlet channel is in communication with an outlet opening on the second surface;
a valve plate having two valve membranes with a same thickness, wherein a plurality of extending supporting elements are disposed around a periphery of each of the two valve membranes for a flexible support, and a hollow hole is formed between each two adjacent extending supporting elements of the extending supporting elements;
a valve chamber base having a third surface, a fourth surface, an inlet valve channel, and an outlet valve channel, wherein the inlet valve channel and the outlet valve channel penetrate the valve chamber base from the third surface to the fourth surface, the two valve membranes of the valve plate are respectively carried on the inlet valve channel and the outlet channel to form a valve structure, and the fourth surface is recessed to form a pressure chamber in communication with the inlet valve channel and the outlet valve channel; and
an actuating device covering the pressure chamber of the valve chamber base;
wherein the valve body, the valve plate, the valve chamber base, and the actuating device are sequentially stacked and assembled with each other, whereby the actuating device controls the inlet channel to draw the liquid water and controls the outlet channel to discharge the liquid water.

15. The portable drinking water generator according to claim 14, wherein the micro liquid pump further comprises:
a valve cover having a first through hole and a second through hole; and
an outer barrel having an inner wall to enclose a hollow space, wherein a bottom of the inner wall has a convex ring structure, wherein the valve body, the valve plate, the valve chamber base, and the actuating device are sequentially stacked in the hollow space, and carried on the convex ring structure, whereby the inlet channel and the outlet channel of the valve body pass through the first through hole and the second through hole of the valve cover, respectively.

16. The portable drinking water generator according to claim 14, wherein a plurality of latch grooves is disposed on the second surface of the valve body, a plurality of latches is disposed on the third surface of the valve chamber base, and the plurality of latches is inserted in the plurality of latch grooves, respectively, whereby the valve chamber base is assembled and positioned on the valve body.

17. The portable drinking water generator according to claim 15, wherein the valve plate of the micro liquid pump is disposed between the valve body and the valve chamber base, wherein the valve plate has a plurality of positioning holes corresponding to the plurality of the latches, whereby the plurality of the latches respectively passes through the plurality of positioning holes so as to position the valve plate.

18. The portable drinking water generator according to claim 17, wherein the second surface of the valve body of the micro liquid pump has a plurality of grooves respectively surrounding the inlet opening and the outlet opening, and the third surface of the valve chamber base has a plurality of grooves respectively surrounding the inlet valve channel and the outlet valve channel, wherein the plurality of grooves of the second surface of the valve body and the plurality of grooves of the third surface of the valve chamber base are respectively provided with a sealing ring to prevent fluid leakage at periphery of the plurality of grooves.

19. The portable drinking water generator according to claim 14, wherein the second surface of the valve body of the micro liquid pump has a convex structure surrounding the inlet opening, and the third surface of the valve chamber base has a convex structure surrounding the outlet valve channel, wherein the convex structure of the inlet opening and the convex structure of the outlet valve channel respectively improve attachment of the two valve membranes of the valve plate, thereby generating a perforce beneficial to securely tightening up the two valve membranes so as to prevent backflow.

20. The portable drinking water generator according to claim 19, wherein the actuating device consists of a vibration plate and a piezoelectric unit, wherein the piezoelectric unit is attached to a surface of the vibration plate and is configured to be deformed when applied with a voltage, and the vibration plate of the actuating device is disposed on the fourth surface of the valve chamber base to cover the pressure chamber.
